(19) United States
(12) Patent Application Publication
(10) Pub. No.: US 2007/0047224 A1
(43) Pub. Date: Mar. 1, 2007

(54) Battery powered magnetically operated light

(76) Inventor: Yu Yi Lee, La Palma, CA (US)

Correspondence Address: Gregg Howard, 16826 Edwards Rd., Cerritos, CA, 90703, US

(21) Appl. No.: 11/213,077

(22) Filed: Aug. 29, 2005

(51) Int. Cl. F21V 33/00

(52) U.S. Cl. 362/132; 362/133; 362/253

(57) ABSTRACT

The invention provides light without the need for electrical wiring. Battery power is applied to the lamp using a magnetically operated switch. The power switch and battery holders are built into the light fixture. The light fixture can be easily mounted in locations such as filing cabinets, desk drawers, bedroom furniture, kitchen drawers, kitchen cabinets, and similar locations. When the device is within close proximity of the magnet, power from the battery is not applied to the lamp. When the light is a specific distance away from the magnet, power from the battery is applied and light is emitted from the lamp.

The invention provides light without the need for electrical wiring. Battery power is applied to the lamp using a magnetically operated switch.

When the device is within close proximity of the magnet, power from the battery is not applied to the lamp. When the light is a specific distance away from the magnet, power from the battery is applied and light is emitted from the lamp.

The light fixture can be easily mounted in locations such as filing cabinets, desk drawers, bedroom furniture, kitchen drawers, kitchens cabinets, and similar locations.

### BACKGROUND OF THE INVENTION

Since its invention, electrically powered lighting has been used for many different applications for both safety and convenience.

Providing illumination is often prohibited using lights wired to power supplies. For example, some furniture, appliances, and cabinetry will not accommodate a wired illumination device. Some locations do not have adequate electrical current available.

What is needed is a battery powered light using a magnetic switch to control power to the lamp. The need for wire between the switch, the illuminating device, and its power supply is eliminated.

### SUMMARY OF THE INVENTION

A battery powered light switched on and off with a magnetic switch. This light can be used in any location that will accommodate the light fixture and the magnet used to trigger the power switch. This device will be affixed in the area to be illuminated without the need to supply electricity to the light via wire.

The power from the battery will be switched on and off using a magnetic switch to eliminate the need for wiring.

When the light is within proximity of the magnetic, the switch keeps the circuit open and the light will remain off.

### BRIEF DESCRIPTION OF THE DRAWINGS

FIG. 1A is a perspective view of the drawer light.

FIG. 1B is a top view of the device in FIG. 1A.

FIG. 1C is a side view of the device in FIG. 1A.

FIG. 2 is an exploded view of the device in FIG. 1A including the magnet that is used to open and close the power switch.

FIG. 3A illustrates the suggested application and locations to use device 8 and device 7 in FIG. 1A used to open and close the power switch.

FIG. 3B illustrates the suggested application and locations to use device 8 and device 7 in FIG. 1A including the magnet used to open and close the power switch.

FIG. 4 is a block diagram of the surface of the electronic components of the device in FIG. 1A.

### DETAILED DESCRIPTION

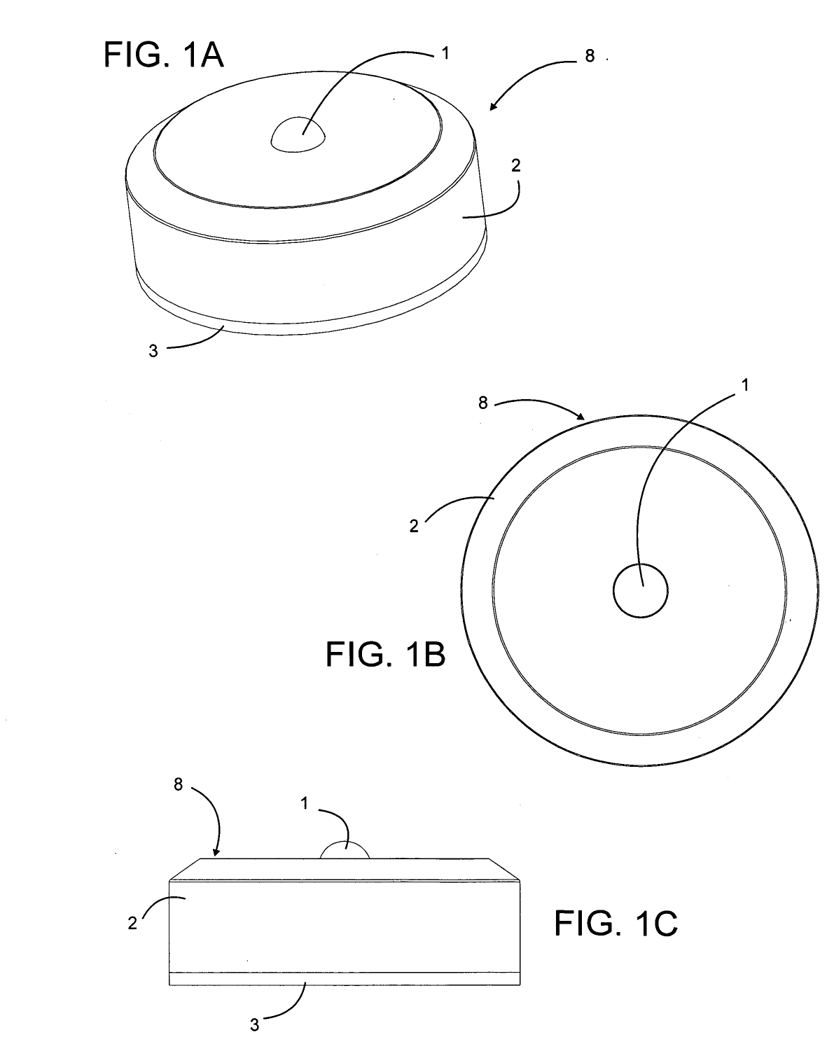

Referring to FIGS. 1A, 1B, and 1C, lamp 1, housing 2, and base 3 is the embodiment of device 8.

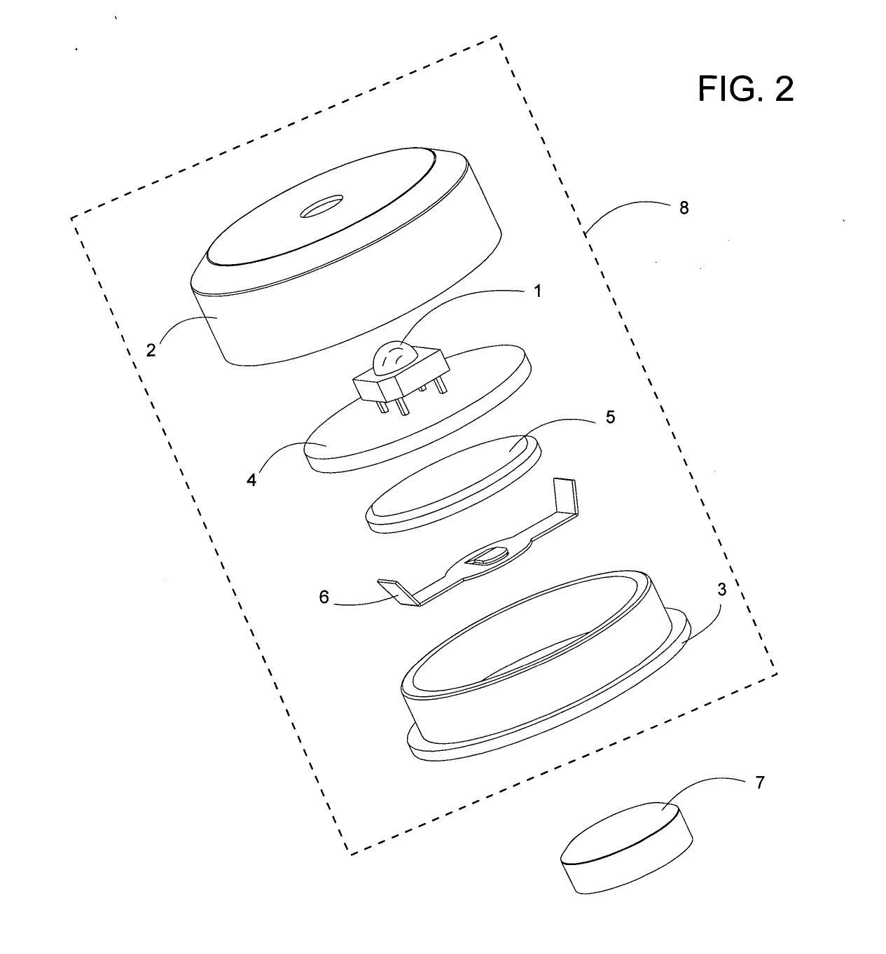

Referring to FIG. 2, the lamp is mounted on the circuit board 4. Battery holder 6 is also soldered to circuit board 4 and holds battery 5 in place. Base 3 and housing 2 enclose lamp 1, circuit board 4, battery holder 6, battery 5 to form device 8.

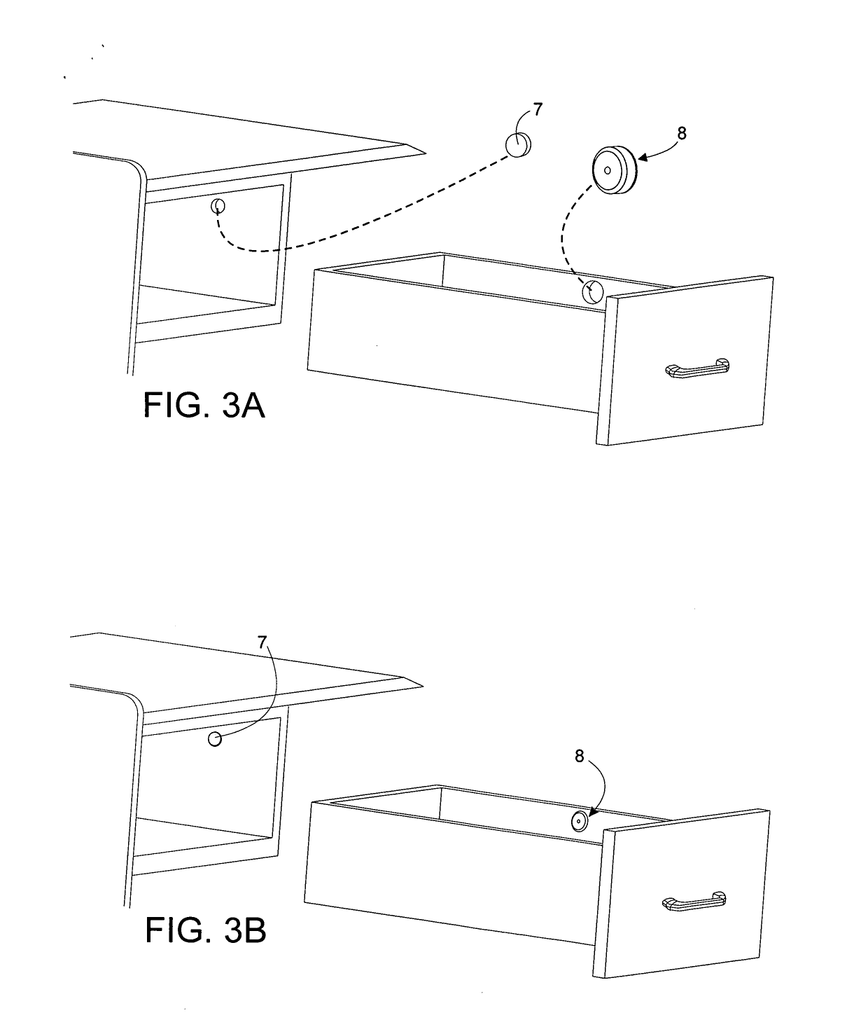

Referring to FIG. 3A, it is suggested that a hole be made so that device 7 and device 8 can be mounted in a fashion that allows device 7 and device 8 to be in close proximity so device 7 will open the switch on device 8 when the drawer in FIGS. 3A and 3B is closed.

FIG. 3B represents device 7 and device 8 installed in a typical application.

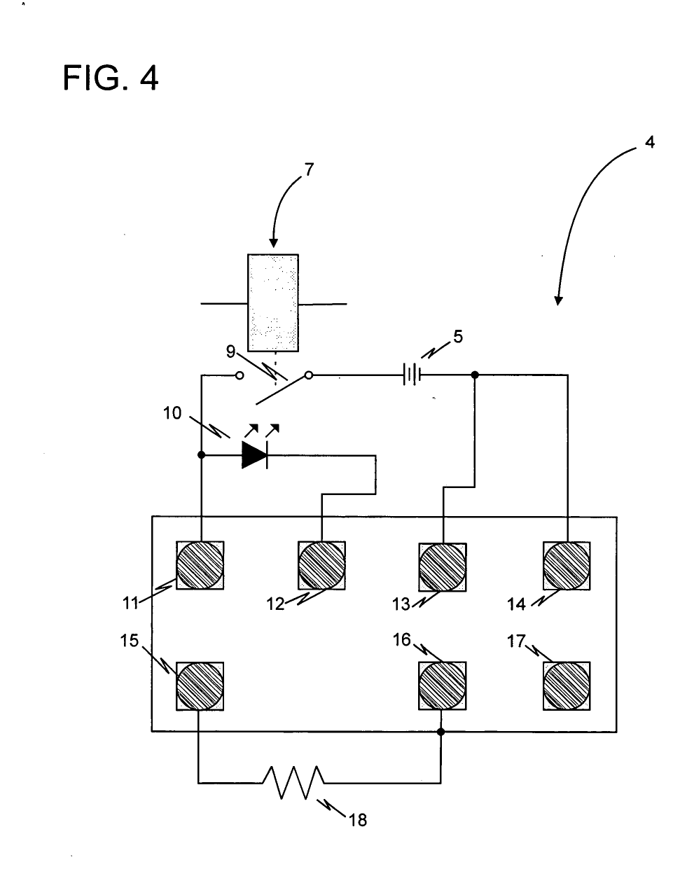

Referring to FIG. 4, device 8 is powered by battery 5. The power from battery 5 is applied to ON\OFF circuit 14 when magnet 7 is moved away from switch 9. Once switch 9 applies power to circuit 14, lamp 10 remains on for a period of time determined by timer 19. Timer 19's parameters are controlled by Oscillators 15 and 16. The amount of time that timer 19 keeps power applied is affected by the resistance value of resistor 18. Timer 19 is reset by reset key 17 when magnet 7 moves within range of switch 9. VDD 11 is the anode for circuit 4. VSS 13 is the cathode for circuit 4. The amount of light emitted by lamp 10 is controlled by circuit 12 which is not part of circuit 4, but is a component of lamp 10.

Device 8 is suitable for drawers used in furniture for home use and office use. The device 8 and magnet 7 are easily installed and will provide light in locations not accessible to conventional wired lighting devices.

What is claimed:

1. Illuminating drawers and cabinets is often prohibited due to the lack of electrical supply or the application does not allow for wiring required for powering an illuminating device.
A small battery powered illuminating device that is turned on and off with a magnetically sensitive switch. The duration of light is controlled by a timing mechanism.
Without the need for supplying electrical current to power the device, the illuminating device will be used typically in drawers making it very easy for manufacturers and users to install the device.
